(19) United States
(12) Patent Application Publication
(10) Pub. No.: US 2017/0042134 A1
(43) Pub. Date: Feb. 16, 2017

(54) Fishing Lure

(71) Applicant: Thomas F. Sandefur, Kuttawa, KY (US)

(72) Inventor: Thomas F. Sandefur, Kuttawa, KY (US)

(21) Appl. No.: 14/999,606

(22) Filed: Jun. 1, 2016

Related U.S. Application Data
(60) Provisional application No. 62/230,281, filed on Jun. 1, 2015.

(51) Int. Cl. A01K 85/10

(52) U.S. Cl. CPC A01K 85/10

(57) ABSTRACT

A fishing lure frame comprising a V-shaped frame having an aperture or loop formed at a vertex of the V-shaped member, the V-shaped member having a first leg and an upper second leg joined at the vertex, the first leg including a lure body extending from a distal end thereof with a hook extending from a distal end of the body and a skirt attaching at a collar formed by a reduced diameter medial portion of the body, the second leg being about three-fourths as long as the first leg and extending at a selected angle of from between 60-120 degrees from the first leg, the second leg extending in spaced apart alignment with the first leg and the second leg including a rotatable bladed attaching to a distal end thereof, the lure body including a plurality of transverse longitudinal members extending from the tip thereof including distal ends having rotatable blades connecting thereto.

### CROSS REFERENCES TO RELATED APPLICATIONS

This application claims priority from U.S. Provisional Application Ser. No. 62/230,281 filed on Jun. 1, 2015 which is incorporated herein in its entirety.

### TECHNICAL FIELD

The present invention relates to the field of fishing lures and more particularly to artificial lures, containing more than one bait and hook, which mimic live bait motion while moving through the water.

### BACKGROUND OF THE INVENTION

Artificial lures often contain portions which resemble small fish, frogs, insects or worms. Such lures often include a spinning portion which reflects light in hopes that the flickering will also attract fish. The shape of such lures often leads to unnatural wobbling, spinning or jerking of the entire lure while moving thorough the water, which may tend to scare fish away.

Attempts at designs which encourage a more natural movement of the lure have included tail members which impart a wiggle as a lure moves through the water. Some designs which are exemplary of such attempts include a tail which extends outward from the body of the lure, a tail with a curved end defining a J-shape, or a tail which includes a forward canted wing piece which fluctuates as the bait is pulled forward and causes the bait to flutter. Other lures include a rigid, canted spoon or wall fixed near a front face of a lure and jutting forward out from the face causing the lure to zig-zag violently while moving through the water. Some examples include a plurality of body parts articulatingly linked together by eyelets or chain links. Still other examples comprise a spoon shaped body which either spins or darts about while being pulled through the water.

### DESCRIPTION OF THE RELATED ART

U.S. Pat. No. 4,998,373 for DOUBLE HOOK LURE by Braswell issued on Mar. 12, 1991 and is incorporated by reference herein teaches a lure with a planar wire frame with a forward eye and trailing hooks which can be fitted with various baits such as artificial worms, feathers, fish, and so on. Braswell includes a shiny spinner element and uses double hooks rather than single hooks which tend to catch more weeds and moss than single hook units. Braswell teaches non-similar baits on the hooks. The present invention uses similar or identical baits to mimic a ‘school’ appearance and does not include shiny spinning elements.

U.S. Pat. No. 3,673,726 for FISH LURE by La Montagne issued on Jul. 4, 1972 teaches a coplanar frame with an eye at one end and at the other end are two similar or identical baits but with treble hooks pivotally attached at the two ends of the frame. Treble hooks catch more weeds and moss when pulled through the water. The present invention contains two individual hooks rigidly attached, one to each end of a V-shaped wire frame.

U.S. Pat. No. 4,671,007 for FISHING LURE DEVICE by Stancyk issued on Jun. 9, 1987 teaches a V-shaped wire frame with an eye at the vertex with a hook and bait pivotally connected at each end of the V. The points of each hook face inward toward a center of the V-shaped frame. Stancyk provides for pivotally connected hooks unlike the present invention which contains a V-shaped frame with rigidly attached hooks.

U.S. Pat. No. 6,155,000 for RATTLE BAIT FISHING LURE by Raven croft issued on Dec. 5, 2000 teaches an approximately V-shaped frame with a eyelet for line attachment at the vertex of the V, a weighted hook and bait rigidly attached to the lower end of the V and a pivotally attached rattle bait at the top end of the V. This contrasts with the present invention which includes a rigidly connected hook at each end of the V-shaped lure.

### SUMMARY OF THE INVENTION

A fishing lure including a generally V-shaped frame having a long bottom first leg and a short top second leg. An eye or attachment loop is formed at the vertex of the V for attachment to a line or leader. A lure body extends at a selected obtuse angle from the end of the long bottom first leg wherein a fishing hook extends from the distal rear end of the lure body curving upward with the point curved over and toward the rear end of the lure body. A skirt is attached to the medial collar portion of the lure body after the head between the main body portion and distal end or tail of the lure. When a fishing line is attached to the eye or loop the lure body is positioned in the horizontal plane and the longer leg extends forward and upward therefrom. The shorter leg extends rearwardly a selected length wherein the distal end of the rear leg is nearly over the distal end of the longer bottom leg; however, the top leg can be shorter or longer and is not critical depending upon whether a hook or spoon blade is attached to the distal end of the top short leg.

In a first preferred embodiment the first and second legs forming the V-shaped frame are formed from a single length of wire, polymer or other synthetic material bent at a selected angle of less than 120 degrees in order that the distal ends are spaced apart from one another and are oriented vertically one above the other when the lure is pulled through the water. A preferred embodiment includes a vertex angle of from 60 to 120 degrees and more preferably form 90 to 120 degrees, and more preferably the vertex legs may include an obtuse angle at the proximate end of one of the legs extending forward toward the eye and an second angle of less than 180 degrees rearward toward the hook so that the combination of the angles of the selected leg (usually the shorter top leg) is approximately at a right angle of about 90 degrees with respect to the long bottom leg.

A pair of transverse wires or synthetic longitudinal members extend from the front portion or tip of the lure body, more particularly from the head extending perpendicular or normal to the lure body. The transverse wires are spaced apart from one another at one or more selected angles and lengths forming whiskers extending outwardly pass the lure body. It is also contemplated that the transverse wires or whiskers could rotate around a spindle like a propellor. In a first preferred embodiment, a spoon or other type of blade is rotatably attached to the distal end of each of the transverse longitudinal members or whiskers. The spoons or blades rotate upon the bait being pulled through the water to replicate a school of scad moving around the lure body. In one preferred embodiment, a distal end loop extends from the top short leg and each of the whiskers or transverse longitudinal members. A rotatable leader including a first loop of wire is connected to each distal end loop and a rotatable wire loop attaches the spoon blade to the distal end of the wire leader. Thus, the lure includes a rotatable top blade, and a plurality of transverse blades extending from the whiskers. The embodiment shown in the drawings include four transverse blades.

In a second embodiment which includes all of the features of the first embodiment, the top leg includes a coaxially mounted spacer such as a bead resting on the proximate end adjacent the eye or attachment loop. A clevis or other means of attachment connects a medial spoon blade to the leg whereby the spoon blade can move from side to side or up and down a fixed distance along the clevis. A second bead spacing member is disposed on the leg after the clevis. A cylindrical member such as a sleeve or spring is mounted coaxially on the short leg adjacent the second bead spacer member and a third bead spacer member is mounted after the sleeve and before the loop on the distal end of the top short leg. The beads and sleeves cover a selected portion of the second top leg and are free to move axially along the leg. A rotatable spoon blade extends from the distal end of the second top leg and over the lure body. Thus, the lure includes a rotatable top blade, a medial blade, and a plurality of transverse blades extending from the whiskers. The embodiment shown in the drawings include four transverse blades.

It is an object of this invention to provide a fishing lure which mimics the movements and motion of live bait within a school of Shad as the lure is pulled through the water.

It is an object of this invention to provide a fishing lure which is weighted and balanced in such a way as to maintain a smooth lifelike movement through the water.

It is an object of this invention to provide a fishing lure which includes a V-shaped frame with an eye at the vertex for connecting to a fishing line and rotatable blades attached at each distal end of the V-shaped frame.

It is an object of this invention to provide a fishing lure wherein the junction between the hook and one end of the V-shaped frame includes at least one pair of transverse longitudinal members or leaders forming whiskers extending from the tip or front portion of the lure body perpendicular thereto with rotatable blades extending from the distal ends thereof.

Other objects, features, and advantages of the invention will be apparent with the following detailed description taken in conjunction with the accompanying drawings showing a preferred embodiment of the invention.

### BRIEF DESCRIPTION OF THE DRAWINGS

A better understanding of the present invention will be had upon reference to the following description in conjunction with the accompanying drawings in which like numerals refer to like parts throughout the views wherein:

FIG. 1 is a perspective view of the fishing lure including a pair of transverse wires radially attached to the front end of a lure body and having including spoons rotatably and attached to the distal ends thereon;

FIG. 2 is a front view of the fishing lure of FIG. 1;

FIG. 3 is a rear view of the fishing lure of FIG. 1;

FIG. 4 is a side view of an embodiment of FIG. 1 showing an attachment notch at a junction of a first top leg and a second bottom leg joined at the vertex and a spoon rotatably attached to the distal end of the first top leg;

FIG. 5 is a top view of the fishing lure of FIG. 4; and

FIG. 6 is a bottom view of the fishing lure of FIG. 3 showing the skirt extending from the lure body covering the hook and first top leg spoon.

### DESCRIPTION OF THE PREFERRED EMBODIMENT

A fishing lure 10 including a generally V-shaped frame having a short top first leg 14 and a long bottom second leg 16. An eye or attachment loop 12 is formed at the vertex of the V for attachment to a line or leader. A lure body 20 extends at a selected angle from the distal end 17 of the long bottom second leg 16 wherein a fishing hook 32 extends from the rear end 21 of the lure body 20 curving upward with the point 31 curved over and toward the rear end of the lure body 20. A skirt 42 is attached to the medial collar portion 21 of the lure body after the integral head and main body 20 and distal end or tail of the lure 10. When a fishing line is attached to the eye or loop the lure body 20 is positioned in the horizontal plane and the shorter top leg 16 extends rearward and upward therefrom. The shorter leg 14 extends rearwardly a selected length wherein the distal end of the rear leg is nearly over the distal end of the longer bottom leg; however, the top leg can be shorter or longer and is not critical depending upon whether a hook or spoon blade is attached to the distal end of the top short leg.

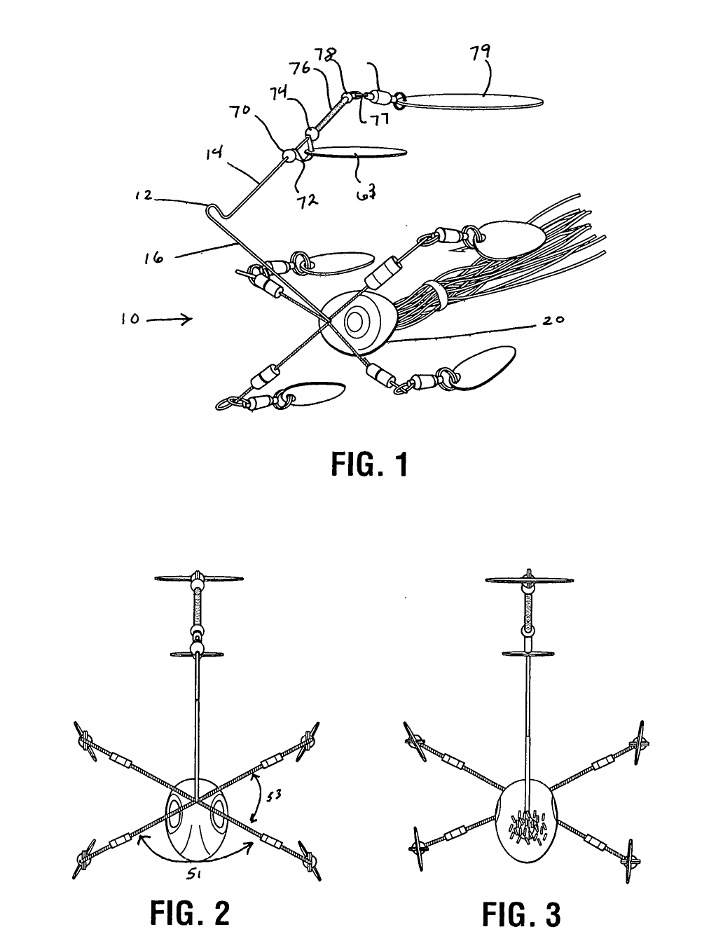

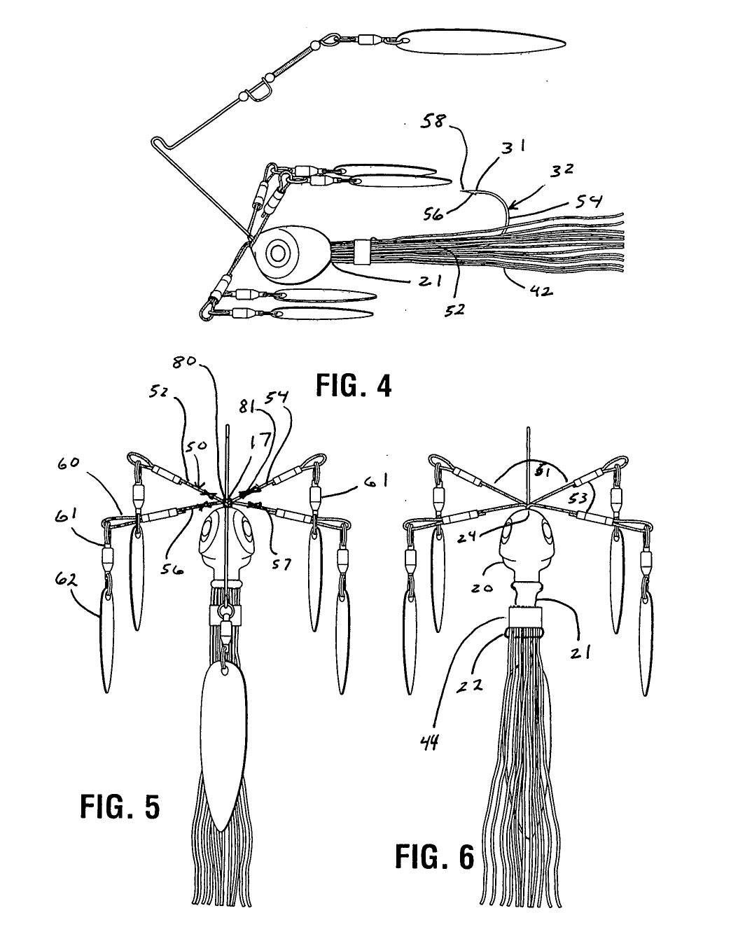

The fishing lure 10 as shown in FIGS. 1-6, includes an approximately V-shaped element positioned as an arrow pointing to the left with a first top leg 14 extending upward and a second bottom leg 16 extending downward in alignment with one another. The top first leg 14 is of a shorter length than the second lower leg 16. The first leg 14 and second leg 16 disposed at a selected angle from one another of about 30 to 90 degrees and more preferably from about 35 to 65 degrees and more preferably from about 35 to 50 degrees and more preferably from about 40 to 45 degrees and as shown in the embodiment of FIG. 1 about 45 degrees. A lure body 20 with a single hook is rigidly attached to the body 20. The hook 32 is coplanar with the V-shaped element. The eye 12 for attaching a fishing line is at the vertex of the V-shaped element.

A fish hook known as a ‘bait hook’ includes a straight portion called a shank 52, a bend 54, a barb 56 and a point 58. The barb 56 helps to hold the bait onto the hook and helps to hold the fish onto the hook once the fish has been hooked. Because the hook 32 is rigidly attached to the body 20 by welding, soldering, silver soldering, or integrally formed with the body.

With reference to the figures, leg 14 is about three-fourths as long as leg 16. The V-shaped element is shown vertical with the vertex pointing to the left. The hook 21 is oriented trailing to the right with the point located above the shank. An approximately tear drop shaped lure body 20 extends from the distal end of the leg 116. The lure body 20 tapers to a point at the rear and forms a neck 21 which encircles the proximate portion of the shank 42. A lip or rim 22 extends radially outward from the rear end of the neck 21. A shirt 42 includes a gathered portion or front sleeve portion which is stretched over the rim 22 and over the neck 21. A rubber band 44 can be fitted over the sleeve of the neck to retain the shirt thereon. The strips or strings of the shirt extends over and covers the hook and/or bait on the hook. It is contemplated that an alternate type of bait may be substituted for the skirt and attached to the hook. Elastomeric baits such as artificial worms, fish, tadpoles, various insects, feathers, skirts and the like are applied to hook 32 of lure 10 to form a complete lure.

It is thought that the nature of the rigid attachment of the hooks to the fishing lure frame 10 provides a smooth lifelike schooling image to fish in that, as the lure is pulled through the water, the leading ends, usually the heads, of the baits move simultaneously and always in the same direction, thus imparting a synchronized motion to the rest of the bodies of the baits. This synchronized motion of the baits generally mimics the movement of a school of fish.

In a first preferred embodiment the first and second legs forming the V-shaped frame are formed from a single length of wire, polymer or other synthetic material bent at a selected angle of less than 120 degrees in order that the distal ends are spaced apart from one another and are oriented vertically one above the other when the lure is pulled through the water. A preferred embodiment includes a vertex angle of from 60 to 120 degrees and more preferably form 90 to 120 degrees, and more preferably the vertex legs may include an obtuse angle at the proximate end of one of the legs extending forward toward the eye and an second angle of less than 180 degrees rearward toward the hook so that the combination of the angles of the selected leg (usually the shorter top leg) is approximately at a right angle of about 90 degrees with respect to the long bottom leg.

A plurality of transverse wires or synthetic longitudinal members 50 extending radially from the front portion 24 or tip of the lure body, more particularly from the head extending perpendicular or normal to the lure body. The transverse members 50 are spaced apart from one another at one or more selected angles and lengths forming whiskers extending outwardly pass the lure body. It is also contemplated that the transverse wires or whiskers could rotate around a spindle like a propellor. As shown in the figures, the top two transverse members 52 and 54 are shorter than the bottom two transverse members; however, it is contemplated that the lower transverse members could be shorter, or the members could be of equal length. The angle 51 between the two top transverse members 52 and 54 is about 135 degrees and typically in a range of from 120 to 160 degrees forming an obtuse angle. The angle 53 between each top transverse members 52, 54 and the bottom transverse members 56, 57 is typically an acute angle of about 35 degrees and ranges from about 25 to 45 degrees.

As shown in the figures, a means of attachment such as a loop 60 extends from the distal end of each one of the transverse members 50. The proximate end of a rotatable leader 61 is attached to the loop 60 and a spoon 62 is attached to the distal end of the rotatable leader to spin freely thereabout.

The spoon or other type of blade 62 is rotatably attached to the distal end of each of the transverse longitudinal members or whiskers. The spoons or blades rotate upon the bait being pulled through the water to replicate a school of scad moving around the lure body. In one preferred embodiment, a distal end loop extends from the top short leg and each of the whiskers or transverse longitudinal members. A rotatable leader including a first loop of wire is connected to each distal end loop and a rotatable wire loop attaches the spoon blade to the distal end of the wire leader. Thus, the lure includes a rotatable top blade, and a plurality of transverse blades extending from the whiskers. The embodiment shown in the drawings include four transverse blades.

In a second embodiment which includes all of the features of the first embodiment, the top leg 14 includes a coaxially mounted spacer such as a bead 70 resting on the proximate end adjacent the eye or attachment loop. A clevis 72 or other means of attachment connects a medial spoon blade to the leg 14 whereby the spoon blade 61 affixed to the clevis 72 can move from side to side or up and down a fixed distance along the upper leg 14. A second bead 74 spacing member is disposed on the leg 14 after the clevis 72. A cylindrical member 76 such as a sleeve or spring is mounted coaxially on the short leg 14 adjacent the second bead spacer member 74 and a third bead spacer member 78 is mounted after the sleeve 76 and before an attachment means such a loop 77 on the distal end 75 of the top short leg 14. The beads and sleeves cover a selected portion of the second top leg and are free to move axially along the leg. A rotatable top spoon blade 79 extends from a leader 61 extending from the distal end of the top leg 14 and over the lure body. The lure includes a rotatable top blade 79, a medial blade 63, and a plurality of transverse blades 62 extending from the whiskers. The embodiment shown in the drawings include four transverse blades.

It is also contemplated that the transverse wires or whiskers could rotate around a spindle 80 like a propellor with rotational blades having longitudinal twist sections 81.

The foregoing detailed description is given primarily for clearness of understanding and no unnecessary limitations are to be understood therefrom, for modification will become obvious to those skilled in the art upon reading this disclosure and may be made upon departing from the spirit of the invention and scope of the appended claims. Accordingly, this invention is not intended to be limited by the specific exemplification presented herein above. Rather, what is intended to be covered is within the spirit and scope of the appended claims.

I claim:

1. A fishing lure frame comprising:
a V-shaped frame having an aperture or loop formed at a vertex of said V-shaped member, said V-shaped member having a first leg and an upper second leg joined at said vertex, said first leg including a lure body extending from a distal end thereof with a hook extending from a distal end of said body and a skirt attaching at a collar formed by a reduced diameter medial portion of said body, said second leg being about three-fourths as long as said first leg and extending at a selected angle of from between 60-120 degrees from said first leg, said second leg extending in spaced apart alignment with said first leg and said second leg including a rotatable bladed attaching to a distal end thereof, said lure body including a plurality of transverse longitudinal members extending from the tip thereof including distal ends having rotatable blades connecting thereto.

2. A fishing lure frame comprising:
a V-shaped frame having an aperture or loop formed at a vertex of said V-shaped member, said V-shaped member having a first leg and an upper second leg joined at said vertex, said first leg including a lure body extending from a distal end thereof with a hook extending from a distal end of said body and a skirt attaching at a collar formed by a reduced diameter medial portion of said body, said second leg being about three-fourths as long as said first leg and extending at a selected angle of from between 60-120 degrees from said first leg, said second leg extending in spaced apart alignment with said first leg and said second leg including a rotatable bladed attaching to a distal end thereof, said lure body including a plurality of transverse longitudinal members extending from the tip thereof including distal ends having rotatable blades connecting thereto; and
said upper leg including a coaxially mounted spacer such as a bead resting on the proximate end adjacent the eye or attachment loop, a clevis or other means of attachment connects a medial spoon blade to the leg whereby the spoon blade can move from side to side or up and down a fixed distance along the clevis, a second bead spacing member is disposed on the leg after the clevis, a cylindrical member such as a sleeve or spring is mounted coaxially on the short leg adjacent the second bead spacer member and a third bead spacer member is mounted after the sleeve and before the loop on the distal end of the top short leg, said beads and sleeves covering a selected portion of the second top leg and are free to move axially along the leg, a rotatable spoon blade extending from the distal end of the second top leg and over the lure body, wherein said lure includes a rotatable top blade, a medial blade, and a plurality of transverse blades extending from the whiskers.
